(19) United States
(12) Patent Application Publication
(10) Pub. No.: US 2016/0370781 A1
(43) Pub. Date: Dec. 22, 2016

(54) PROGRAMMABLE CONTROLLER

(71) Applicant: KABUSHIKI KAISHA YASKAWA DENKI, Kitakyushu-shi (JP)

(72) Inventors: Masaomi KUDO, Kitakyushu-shi (JP); Koji HARA, Kitakyushu-shi (JP)

(73) Assignee: KABUSHIKI KAISHA YASKAWA DENKI, Kitakyushu-shi (JP)

(21) Appl. No.: 15/182,621

(22) Filed: Jun. 15, 2016

(30) Foreign Application Priority Data
Jun. 18, 2015 (JP) 2015-122869

(51) Int. Cl. G05B 19/042

(52) U.S. Cl. CPC G05B 19/0426; G05B 2219/23427

(57) ABSTRACT

A programmable controller to control a control machine includes an arithmetic processor, a non-volatile storage, a volatile storage, and a selection transferor. The non-volatile storage stores a plurality of control projects executable by the arithmetic processor to perform control processing of the control machine. The volatile storage is configured to store at least one control project among the plurality of control projects. The selection transferor is configured to select the at least one control project from among the plurality of control projects stored in the non-volatile storage and transfer the selected one control project to the volatile storage so that the arithmetic processor executes the at least one control project stored in the volatile storage.

### CROSS-REFERENCE TO RELATED APPLICATIONS

The present application claims priority under 35 U.S.C. §119 to Japanese Patent Application No. 2015-122869, filed Jun. 18, 2015. The contents of this application are incorporated herein by reference in their entirety.

### BACKGROUND

1. Field of the Invention

The embodiments disclosed herein relate to a programmable controller.

2. Discussion of the Background

Japanese Unexamined Patent Application Publication No. 2003-167608 discloses a programmable controller that stores a sequence program prepared by the user in a program memory such as EEPROM.

### SUMMARY

According to one aspect of the present disclosure, a programmable controller to control a control machine includes an arithmetic processor, a non-volatile storage, a volatile storage, and a selection transferor. The non-volatile storage stores a plurality of control projects executable by the arithmetic processor to perform control processing of the control machine. The volatile storage is configured to store at least one control project among the plurality of control projects. The selection transferor is configured to select the at least one control project from among the plurality of control projects stored in the non-volatile storage and transfer the selected one control project to the volatile storage so that the arithmetic processor executes the at least one control project stored in the volatile storage.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram schematically illustrating a configuration of a machine control system including a programmable controller according to an embodiment;

FIG. 2 is a block diagram illustrating a storage configuration of various information in a memory;

FIG. 3 is a table illustrating exemplary specific contents of a definition file of each preserved project in FIG. 2;

FIG. 4 illustrates an exemplary specific description of a control program of each preserved project in FIG. 2;

FIG. 5 is a flowchart of a control procedure of a system program executed in a ROM by a CPU of the programmable controller;

FIG. 6 is a block diagram illustrating a storage configuration of various information in the memory in a modification in which a plurality of preserved projects are stored in a flash memory;

FIG. 7 is a table illustrating exemplary specific contents of a standard definition file of each preserved project in FIG. 6;

FIG. 8 is a table illustrating exemplary specific contents of a standard +first option definition file of a preserved project 1 in FIG. 6;

FIG. 9 is a table illustrating exemplary specific contents of a standard +second option definition file of a preserved project 2 in FIG. 6;

FIG. 10 illustrates an exemplary specific description of a common control program of each preserved project in FIG. 6;

FIG. 11 is a block diagram in a case of a modification by network connection, illustrating an irregular connection configuration when a production machine includes standard shafts and one option shaft; and

FIG. 12 is a table illustrating exemplary specific contents of a standard +first option definition file corresponding to the connection configuration of FIG. 11.

### DESCRIPTION OF THE EMBODIMENTS

The embodiments will now be described with reference to the accompanying drawings, wherein like reference numerals designate corresponding or identical elements throughout the various drawings.

### Schematic Configuration of Machine Control System

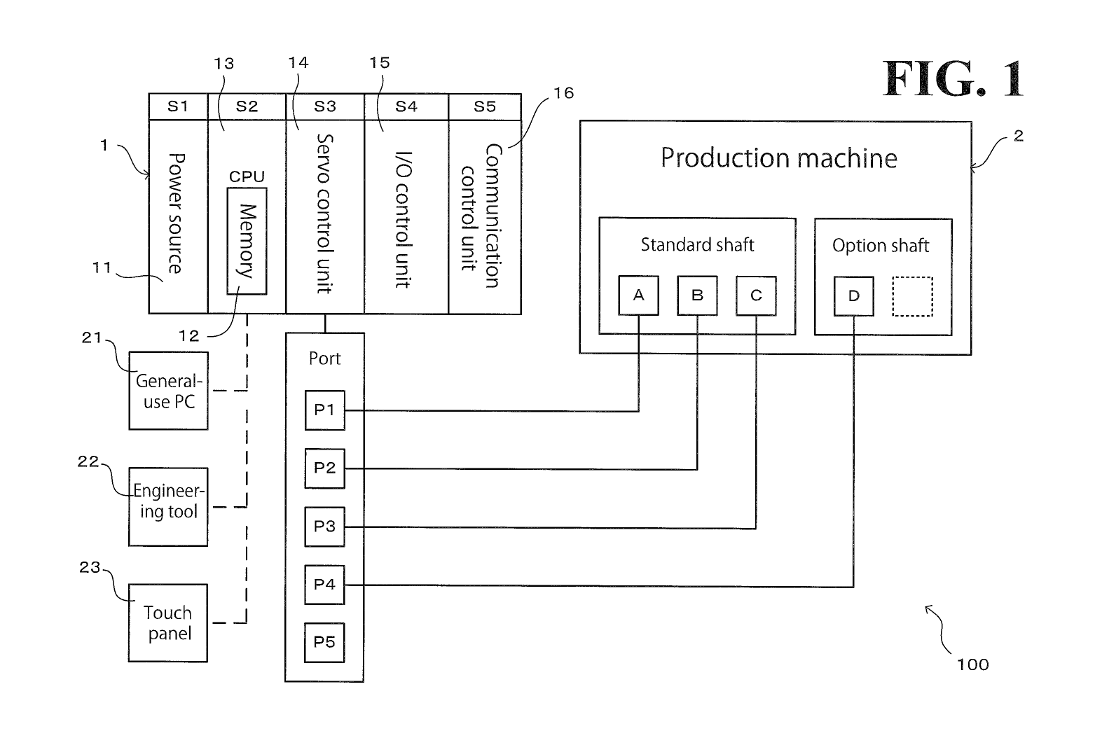

FIG. 1 is a block diagram illustrating a machine control system including a programmable controller according to the embodiment. In FIG. 1, the machine control system 100 includes the programmable controller 1 and a production machine 2, which is an exemplary control machine.

The programmable controller 1 is what is called an upper-level controller to control operation and information of control elements of the production machine 2 based on a control program and definition files stored in a memory, described later. In the illustrated example, the programmable controller 1 is provided with a power source 11, a CPU 13, a servo control unit 14, an I/O control unit 15, and a communication control unit 16, which correspond to slots S1 to S5 of the main body of the programmable controller 1 in ascending order. The CPU 13 includes the memory 12.

The power source 11 functions to convert three-phase AC power supplied from a commercial power source, not illustrated, into DC power and supply the converted power to each component of the programmable controller 1.

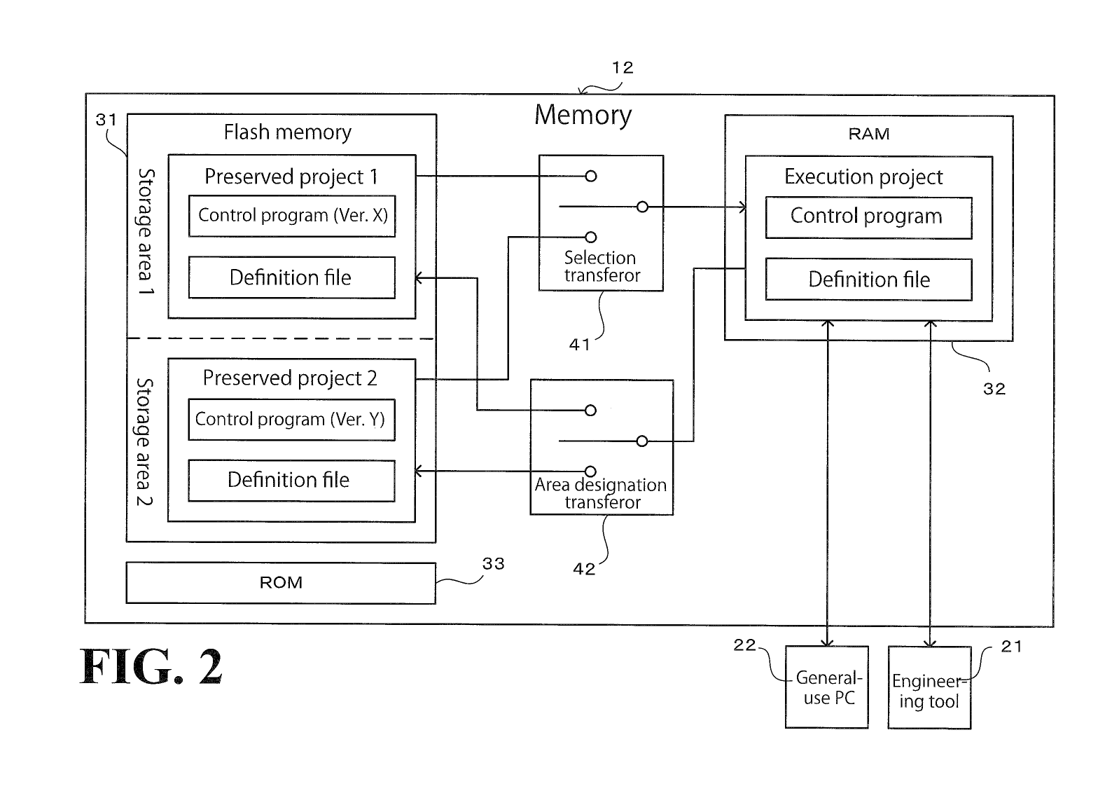

The CPU 13 (which is the arithmetic processor) functions to transmit and receive commands and information to and from each component of the programmable controller 1 based on a control program and a definition file (see FIG. 2, described later) stored in the incorporated memory 12 (storage) so as to control the whole programmable controller 1. A configuration of the memory 12 and the contents of stored information will be described in detail later.

The production machine 2, described later, includes drive shafts (actuators) as the control elements. The servo control unit 14 is connected to each of the drive shafts and functions to output commands from the CPU 13 to the drive shafts.

The production machine 2, described later, includes auxiliary devices such as various sensors, lamps, and solenoids as the control elements. The I/O control unit 15 is connected to the auxiliary devices and functions to make commands and information input and output between the I/O control unit 15 and the CPU 13.

The communication control unit 16 is connected to programmable controllers of other machine control systems through suitable communication lines and functions to control transmission and reception of information to and from the CPU 13 so as to perform cooperation with the programmable controllers.

The servo control unit 14, the I/O control unit 15, and the communication control unit 16 each include a plurality of ports (which are the connectors), and are connected to a plurality of control elements of the production machine 2 and other programmable controllers through the ports. The plurality of ports are discriminated in advance as input and output ports of commands and information so as to specify the ports as hardware. In order to avoid complication of the illustration and facilitate description, assume that the servo control unit 14, for example, includes five ports P1, P2, P3, P4, and P5 in FIG. 1. Only the connection relationships between the ports P1 to P5 of the servo control unit 14 and drive shafts A, B, C, and D of the production machine 2 are illustrated in FIG. 1 and will be described below. In the example of this embodiment, outlets of male plugs of cables are supposed as specific configurations of the ports P1 to P5. Other coupling configurations such as female connectors and sockets, however, may be employed. It is noted that reference numerals P1 to P5 of the ports correspond to the specification information disclosed in the claims.

One of a general-use personal computer 21 (abbreviated to general-use PC in FIG. 1; the same applies below), an engineering tool 22, and a touch panel 23 is connectable to the CPU 13. The general-use PC 21 is a tool for the developer and used for developing, for example, a control project, described later, including the control program (see FIG. 2, described later). The engineering tool 22 is a tool for the operator and used for adjusting the control project. The touch panel 23 is a tool for the operator and used for operating the machine control system 100 based on the control project. The general-use PC 21, the engineering tool 22, and the touch panel 23 each include a suitable operation unit and display, which make it possible to, for example, display and set the stored contents of the memory 12 and various parameters, and input various commands.

The production machine 2 is an assembly of mechanical elements to perform predetermined actions by driving movable portions by rotary or linear motors (actuators) incorporated in the production machine 2. Additionally, the production machine 2 performs cooperative control using auxiliary devices such as various sensors, lamps, and solenoids. Each of these motors and a servo amplifier (not illustrated) to control the motor will be referred to as drive shaft. The production machine 2 in the example illustrated in FIG. 1 includes three standard shafts A, B, and C and one option shaft D. The standard shafts A, B, and C are drive shafts that are required minimum for making the production machine 2 perform standard actions. The option shaft D is a drive shaft to make the production machine 2 perform an action added to the standard actions by the operator as desired. In the example illustrated in FIG. 1, the drive shafts A to D are connected in sequence to the ports P1 to P4 in ascending order. In general, the normal production machine 2 includes, as control elements, a plurality of auxiliary devices connected to the I/O control unit 15 in addition to the drive shafts connected to the servo control unit 14 of the programmable controller 1. As described above, however, FIG. 1 only illustrates the connection relationships between the ports P1 to P5 of the servo control unit 14 and the drive shafts of the production machine 2.

As described above, the programmable controller 1 is connected to a plurality of control elements (drive shafts and auxiliary devices) of the production machine 2 through the ports. The CPU 13 performs the input and output of commands or information with respect to the control elements in accordance with the control program. Thus, the programmable controller 1 controls actions of the production machine 2. The plurality of ports of the programmable controller 1 itself are compatible with each other as hardware. Consequently, other than the control program, definition files are prepared in advance (see FIG. 2, described later). A definition file defines, as software, which control elements are actually connected to which ports.

### Properties of this Embodiment

A control program is prepared by, for example, the engineering tool and the general-use PC provided externally. A volatile RAM (see FIG. 2, described later) having a relatively high access speed is incorporated in the memory. As described later, the programmable controller loads the control program into the RAM and causes a CPU to execute the control program so as to perform control processing of the control machine. The control program stored in the RAM is transferred to and stored in a non-volatile flash memory (see FIG. 2, described later). Thus, even when the power supply is interrupted by, for example, a restart, the flash memory keeps storing the control program without erasing it.

In the development of the control program, generally, revision such as malfunction correction and addition of functions is repeatedly performed. In order to inspect malfunction of a new version, operation of the new version is often compared with operation of previous versions. When the programmable controller reads the control program from a component such as the engineering tool, however, reading is performed through, for example, communication interface and consequently takes time. When the control program is transferred from the engineering tool to the flash memory, transfer is performed through the RAM and consequently complicates work. Therefore, each time revision is repeated however slightly and comparison with operation of previous versions is performed, it is necessary to transfer the control program from the engineering tool to the flash memory. This transfer work takes time and labor and complicates the operation comparison.

In view of this, in this embodiment, the flash memory stores a plurality of control programs, and a selection transferor selects one of the plurality of control programs stored in the flash memory and transfers the selected control program to the RAM. Thus, the single programmable controller is capable of storing the plurality of control programs of different revised versions and executing each of the control programs case by case. Consequently, even when comparison of operation of the control programs is repeated, it is possible to reduce frequency of reading from the engineering tool and facilitate the operation comparison while saving time.

### Storage Configuration of Memory

FIG. 2 illustrates a storage configuration of various kinds of information in the memory 12. In FIG. 2, the memory 12 includes a flash memory 31, a RAM 32, and a ROM 33.

The flash memory 31 (which is the non-volatile storage) is what is called a non-volatile storage in which the stored contents are readable and rewritable when the power is supplied and from which the stored contents are not erased even when the power supply is interrupted. In this embodiment, the flash memory 31 stores a preserved project (control project) in each of two different storage areas. The preserved project is made up of a combination of one control program and one definition file. Basically, capacity allocation is set to uniformly allocate the overall storage capacity of the flash memory 31 to the number of the prepared storage areas (two in this embodiment). The control program describes a control procedure executable by the CPU 13 to perform the input and output of commands or information with respect to the control elements of the production machine 2 based on the definition file in the same control project. Detailed description will be made later on specific contents of the common control program and the definition files. The flash memory 31 may be replaced with a hard disk drive, which is also a non-volatile storage.

The RAM 32 (which is the volatile storage) is what is called a volatile storage in which the stored contents are readable and rewritable when the power is supplied and from which the stored contents are erased when the power supply is interrupted. The RAM 32 stores one execution project (control project) made up of the combination of the one control program and the one definition file transferred from the flash memory 31. The access speed of the RAM 32 is relatively high. The CPU 13 accesses and executes the execution project stored in the RAM 32 so as to increase the processing speed.

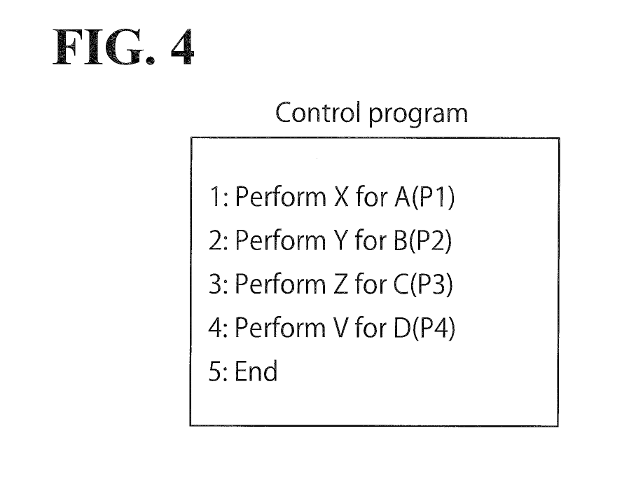

The ROM 33 is what is called a non-volatile storage in which the stored contents are only readable when the power is supplied and from which the stored contents are not erased even when the power supply is interrupted. In this embodiment, the ROM 33 stores a system program for, for example, transferring the control project from the flash memory 31 to the RAM 32 when the programmable controller 1 is powered (see FIG. 4, described later).

When the control project is transferred from the flash memory 31 to the RAM 32, the selection transferor 41 selects one of the plurality of storage areas in the flash memory 31 and transfers the control project (preserved project) stored in the selected storage area to the RAM 32. When the control project is transferred from the RAM 32 to the flash memory 31, an area designation transferor 42 selects one of the plurality of storage areas in the flash memory 31 and transfers the control project (execution project) stored in the RAM 32 to the selected storage area. In the example of this embodiment, the selection transferor 41 and the area designation transferor 42 each include a hardware switch such as a rotary switch. The operator manually operates the selection transferor 41 and the area designation transferor 42 so as to select the storage area in the flash memory 31 as an access target. It is noted that the selection transferor 41 and the area designation transferor 42 may be arranged to set the contents of a system register (not illustrated) in the CPU 13 so as to select the storage area by means of software. The selection transferor 41 and the area designation transferor 42 may be integral to each other.

### Exemplary Specific Contents of Definition Files

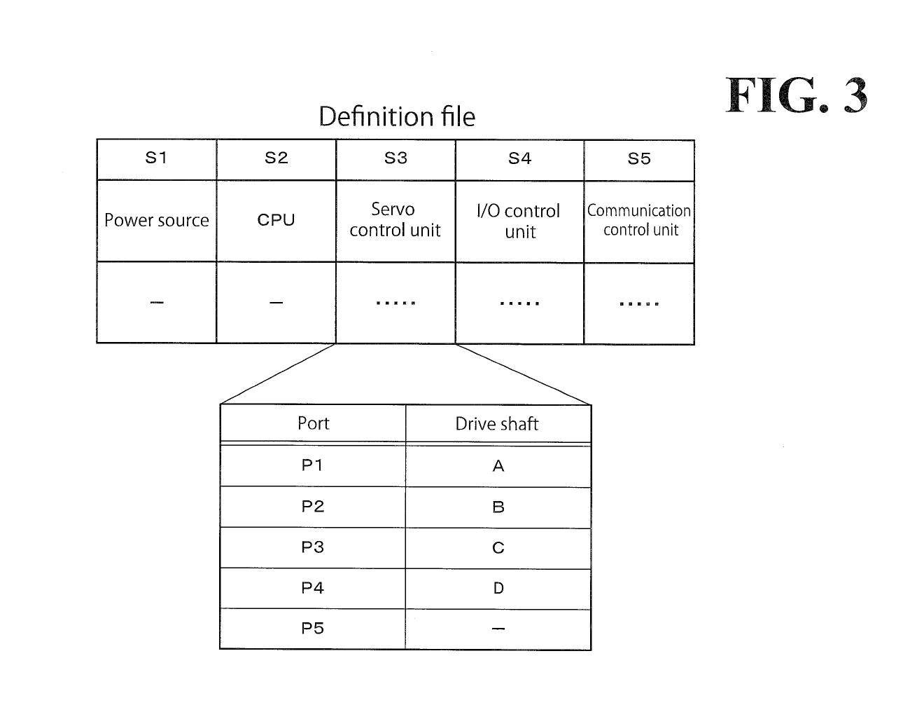

FIG. 3 illustrates exemplary specific contents of a definition file of each preserved project in FIG. 2. The contents of the definition file are illustrated in a table indicating a connection combination of the ports and drive shafts corresponding to the connection configuration of the production machine 2.

FIG. 3 illustrates an exemplary standard +first option definition file corresponding to the connection configuration illustrated in FIG. 1. The standard +first option definition file causes the production machine 2 to perform an action by the option shaft D in addition to standard actions by the standard shafts A, B, and C. The contents of the definition file are described in a table indicating a connection configuration for each of the control units attached to the respective slots. It is noted that FIG. 3 illustrates an example in which only a connection configuration of the servo control unit 14 is extracted, that is, only a combination of connections between the ports P1 to P5 and the drive shafts A to D, as follows, is extracted: the standard shaft A is connected to the port P1; the standard shaft B is connected to the port P2; the standard shaft C is connected to the port P3; and the option shaft D is connected to the port P4. That is, the illustrated example is the definition file in the case of the connection configuration illustrated in FIG. 1 and causes the production machine 2 to perform not only the standard actions but also the action of the option shaft D.

It is noted that since the ports P1 to P5 are compatible with each other as hardware, as described above, the contents of the definition file may have various combinations other than the illustrated example. It suffices that the ports P1 to P5 and the drive shafts A to D are actually connected in accordance with combinations of definition files. FIG. 3 illustrates only the definition file indicating the connection configuration of the ports P1 to P5 of the servo control unit 14 and the drive shafts of the production machine 2. The I/O control unit 15, however, may also include similar ports, and a definition file may be separately prepared which indicates a connection configuration of the ports and auxiliary devices of the production machine 2 or the same definition file for the drive shafts may be employed.

### Control Program

In a non-limiting embodiment, an exclusive control program that is executed in accordance with only the above-described standard +first option definition file illustrated in FIG. 3 is described to perform drive processing X, Y, Z, and V for the drive shafts A, B, C, and D in a suitable order, as illustrated in FIG. 4. That is, it suffices that based on the standard+first option definition file, commands are unconditionally output to the ports P1 to P4 corresponding to the respective drive shafts.

### Memory Management Method

With the storage configuration of the memory 12 illustrated in FIG. 2, selection transfer and execution of the control project made up of the combination of the control program and the definition file described above are managed. In the storage configuration of the memory 12, the operator temporarily stores in the RAM 32 the common control program and each definition file, which have been prepared in the general-use PC 21 or the engineering tool 22, and the control program and the definition file are collectively regarded as the control project. Then, the operator selects one of the storage areas in the flash memory 31 by the area designation transferor 42, and transfers the control project in the RAM 32 to the selected storage area to store the control project as a preserved project. Preservation operation of such preserved projects is performed in such a manner that preserved projects that have control programs in different revised versions (Ver. X and Ver. Y in the illustrated example) are preserved in different storage areas.

Next, the operator sets by the selection transferor 41 the preserved project stored in which of the storage areas in the flash memory 31 is transferred and executed as an execution project, and in this state, the operator restarts the programmable controller 1. Thus, in accordance with the system program in the ROM 33, the CPU 13 transfers the preserved project from the selected storage area in the flash memory 31 to the RAM 32 and regards the preserved project as the execution project. Then, the CPU 13 executes the execution project stored in the RAM 32 so as to control the production machine 2.

When the operator (developer) alternately switches between the plurality of preserved projects including the control programs in different revised versions so as to repeatedly perform their operation comparison, switching and execution can be performed with the single programmable controller. That is, when the plurality of preserved projects in different revised versions are prepared in the storage areas in the flash memory 31 in advance, it is possible to reduce frequency of complicated transfer operation from the general-use PC 21 and the engineering tool 22 provided externally so as to improve development efficiency of the control projects.

### Control Flow of System Program

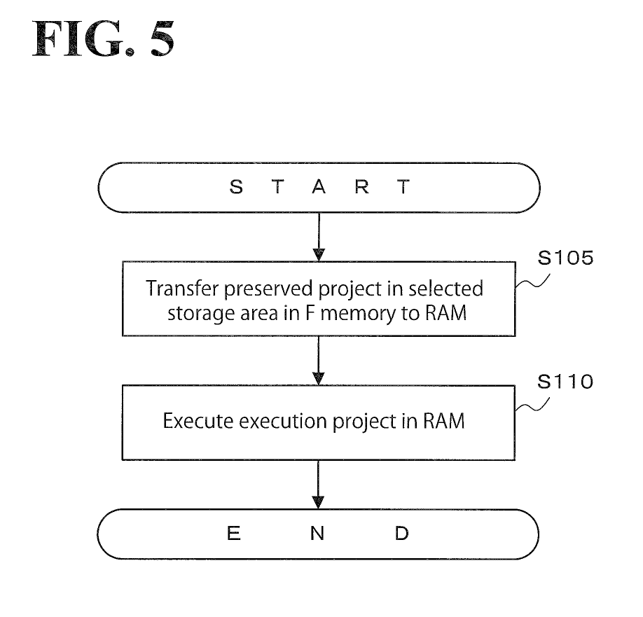

A control procedure of the system program executed in the ROM 33 by the CPU 13 in order to implement the above-described functions will be described step by step by referring to FIG. 5. In FIG. 5, the processing described in this flow is started when the programmable controller 1 is restarted (or powered and started up) after the operator operates the selection transferor 41 in advance to set the preserved project in which storage area is applied. It is noted that when the programmable controller 1 is restarted, the RAM 32 is in an initial state in which all the stored contents are erased.

First, at step S105, the CPU 13 transfers the preserved project from the storage area in the flash memory 31 (abbreviated to F memory in FIG. 5), which has been selected by the selection transferor 41, to the RAM 32 and sets the preserved project as the execution project.

Next, the processing proceeds to step S110, and the CPU 13 executes the execution project in the RAM 32, which has been set at step S 105. Thus, the CPU 13 controls actions and information of the control elements of the production machine 2 through the ports. Then, this flow is ended.

### Effects of this Embodiment

As has been described heretofore, with the programmable controller 1 of this embodiment, the flash memory 31 stores the plurality of control projects, and the selection transferor 41 selects one of the plurality of control projects stored in the flash memory 31 and transfers the selected control project to the RAM 32. Thus, the operator (developer, in particular) is capable of storing and switching between the plurality of control projects in different revised versions so as to execute the control projects using the single programmable controller 1. Consequently, even when operation comparison of the control projects is repeated, it is possible to reduce reading frequency from the general-use PC 21 and the engineering tool 22 and to perform the operation comparison readily and quickly. This improves development efficiency of the control projects. Moreover, even when the power supply is interrupted, the plurality of control projects stored in the flash memory 31 are all kept stored without being erased. At a start-up, only the required control project is loaded into the RAM 32, which has a relatively high access speed, and executed. This improves the processing speed of control and memory efficiency.

In this embodiment, in particular, the programmable controller 1 includes the area designation transferor 42 to transfer the control project stored in the RAM 32 to a suitable storage area in the flash memory 31. Thus, it is possible to suitably and readily perform such management as to which of the plurality of control projects stored in the flash memory 31 is erased or overwritten.

In this embodiment, in particular, the selection transferor 41 substantially selects and transfers the control project only when the programmable controller 1 to execute the system program in FIG. 5 is started up. It is not preferable from a safety point of view to change the control project while the power is supplied. Consequently, only when the programmable controller 1 is started up (powered), the selection transferor 41 selects and transfers the control project to improve safety.

### Modifications

The present invention is not limited to the above-described embodiment. Various modifications are possible without departing from the subject matter. Such modifications will now be described.

1. When each Preserved Project Includes a Plurality of Definition Files

To a control machine such as the production machine 2, control elements such as drive shafts and auxiliary devices may be added optionally to change the connection configuration of the control machine in various manners. In this case, it is preferable to also prepare definition files corresponding to connection configurations of the control machine individually. Each time the connection configuration of the control machine is changed however slightly, however, a corresponding definition file is input to the programmable controller 1 anew, and this operation is complicated. In view of this, a plurality of definition files and a control program used for the definition files in common may be collected to constitute one preserved project, and a plurality of preserved projects having control programs in different versions may be stored in the flash memory 31.

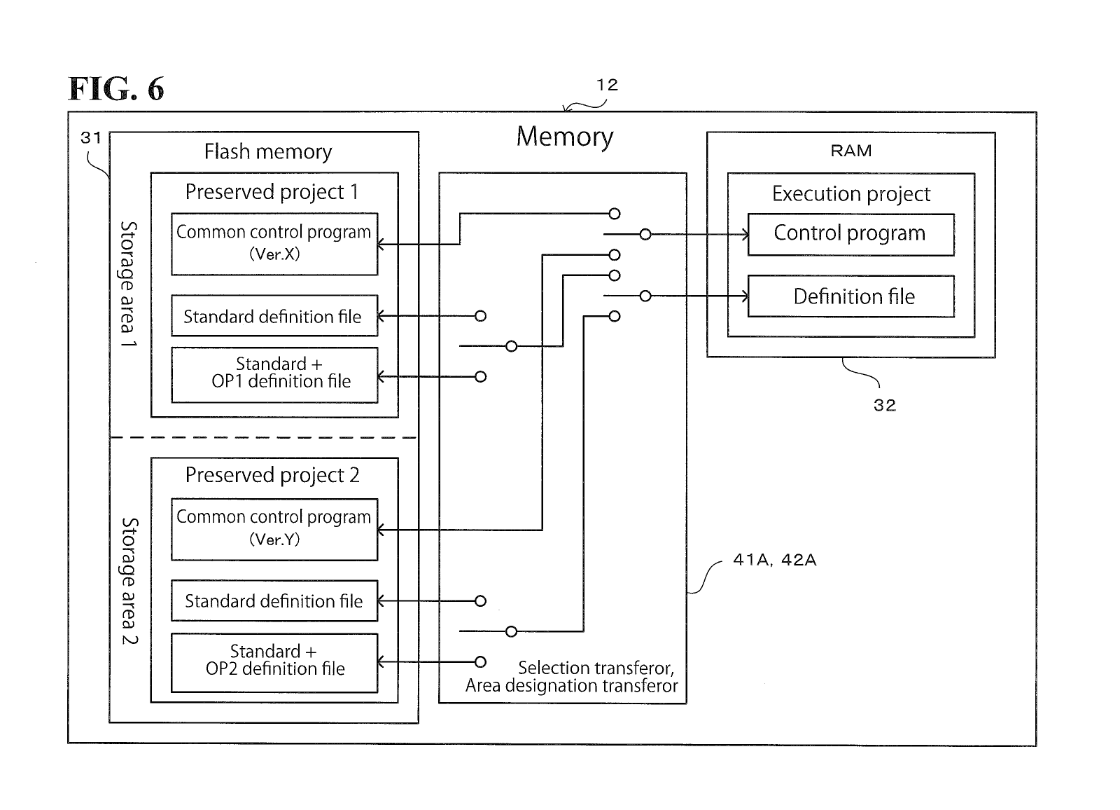

FIG. 6 illustrates a storage configuration of various information in the memory 12 in this modification, and corresponds to FIG. 2. In FIG. 6, in the flash memory 31, one preserved project is stored in each storage area, and each preserved project is made up of one common control program and a plurality of definition files. In the illustrated example, a preserved project 1 stored in a storage area 1 includes a plurality of definition files, which are a standard definition file and a standard+first option definition file (abbreviated to standard+OP1 definition file in FIG. 6). A preserved project 2 stored in a storage area 2 includes a plurality of definition files, which are the standard definition file and a standard+second option definition file (abbreviated to standard+OP2 definition file in FIG. 6).

The RAM 32 stores one execution project made up of a combination of one common control program and one definition file, which have been transferred from the flash memory 31.

When the control project is transferred from the flash memory 31 to the RAM 32, a selection transferor 41A selects one of a plurality of storage areas in the flash memory 31, and further selects one of the definition files in the preserved project in the selected storage area. Then, the common control program and the definition file in the selected preserved project are transferred to the RAM 32 and regarded as the execution project. When the control project is transferred from the RAM 32 to the flash memory 31, an area designation transferor 42A selects one of the plurality of storage areas in the flash memory 31, and the common control program and the definition file stored in the RAM 32 are transferred to overwrite the preserved project in the corresponding storage area. It is noted that to avoid complication of the illustration of FIG. 6, the selection transferor 41A and the area designation transferor 42A are illustrated as being integral to each other, and illustration of the ROM 33 is omitted.

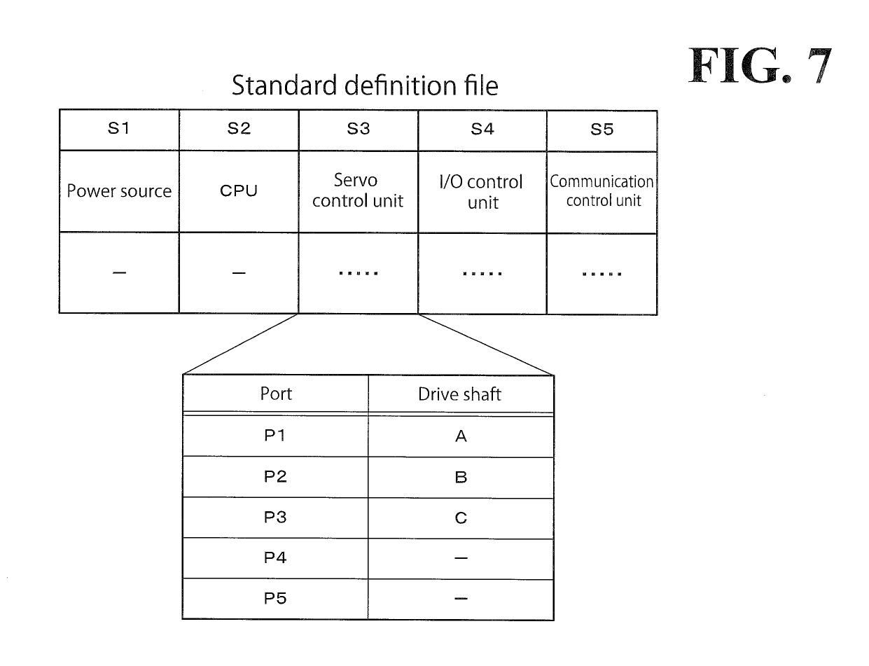

FIGS. 7 to 9 respectively illustrate exemplary specific contents of the standard definition file, the standard+first option definition file, and the standard+second option definition file illustrated in FIG. 6.

The standard definition file of FIG. 7 corresponds to a connection configuration for making the production machine 2 drive only the three standard drive shafts A, B, and C to perform standard actions. In the illustrated example, the standard shaft A is connected to the port P1. The standard shaft B is connected to the port P2. The standard shaft C is connected to the port P3.

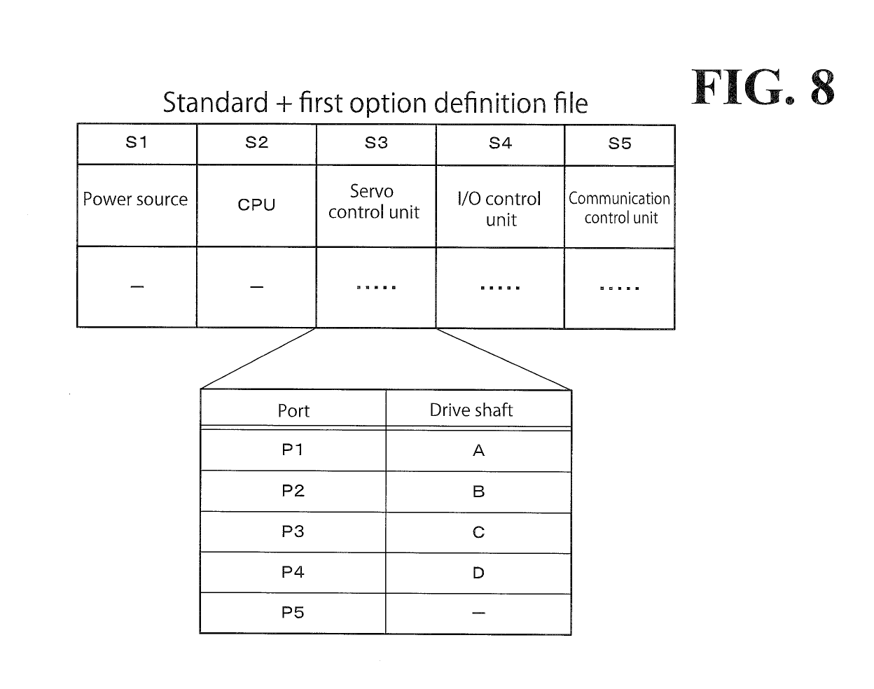

The standard+first option definition file of FIG. 8 corresponds to a connection configuration for making the production machine 2 perform an action of the option shaft D in addition to the standard actions. The example illustrated in FIG. 8 is the connection configuration of the standard definition file to which connection of the option shaft D to the port P4 is added.

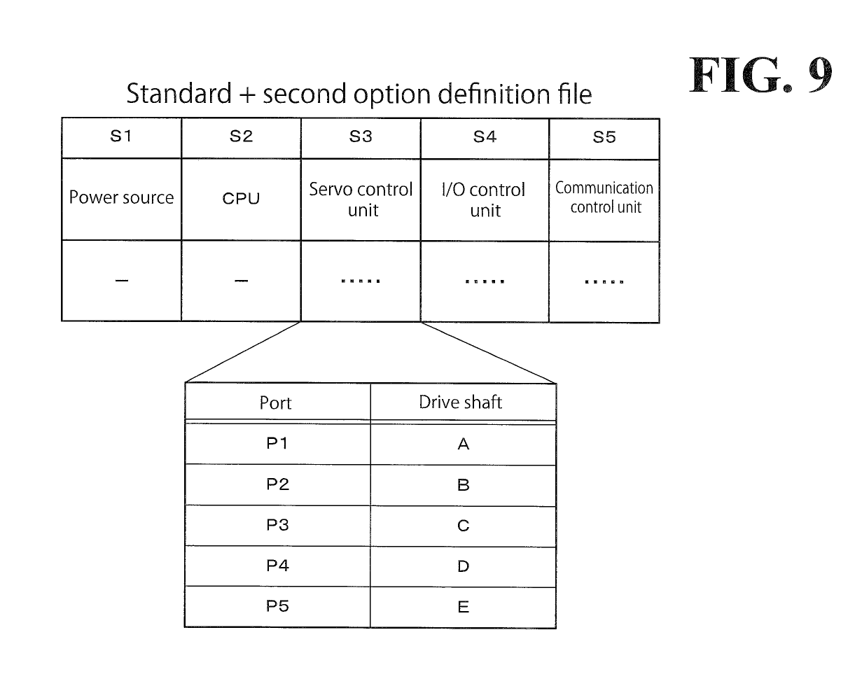

The standard+second option definition file of FIG. 9 corresponds to a connection configuration for making the production machine 2 perform the action of the option shaft D and an action of an option shaft E, not illustrated, in addition to the standard actions. The example illustrated in FIG. 9 is the connection configuration of the standard+first option definition file to which connection of the option shaft E to the port P5 is added.

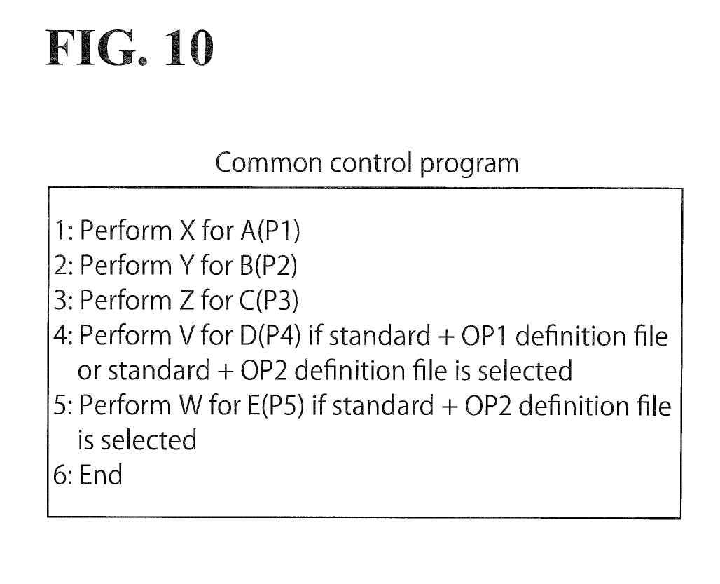

FIG. 10 illustrates exemplary specific contents of the common control program illustrated in FIG. 6. The common control program is described in such a manner that even when the common control program is combined with any of the plurality of definition files prepared in advance in the preserved project, the common control program can be appropriately executed. Specifically, as illustrated in FIG. 10, the drive processing X, Y, and Z is unconditionally performed for the respective drive shafts A, B, and C. Concerning the option shaft D, however, only when it is confirmed that one of the standard+first option definition file and the standard+second option definition file, which define connection of the option shaft D, is selected, the drive processing V is performed (a command is output to the corresponding port P4). Concerning the option shaft E, only when it is confirmed that the standard+second option definition file, which defines connection of the option shaft E, is selected, the drive processing W is performed (a command is output to the corresponding port P5). Thus, the drive processing is performed for each of the option shafts under the connection conditions so as to apply the single common control program to the standard definition file and the option definition files in common. Revised versions of the common control program differ in detailed contents of the drive processing for the drive shafts and description of the control procedure.

As described above, with the programmable controller 1 of this modification, the plurality of definition files and the control program used for the definition files in common are collected to constitute one preserved project. The version of the common control program is changed to store a plurality of control projects in the flash memory 31. The selection transferor 41A selects one of the plurality of definition files in the selected preserved project, and transfers the selected definition file and the common control program of the preserved project to the RAM 32 so as to set the execution project. Thus, even when the operator repeats revision of the common control program and change of the connection configuration of the control machine, the operator merely operates the selection transferor 41A to appropriately control the control machine of the connection configurations based on the corresponding definition files. This facilitates appropriate control in accordance with various changes in the connection configuration of the control machine.

In this modification, in particular, the control program in each preserved project is described as a common control program executable by the CPU 13 to perform the input and output of commands or information with respect to only the control elements that are connected in a manner defined by the definition file selected by the selection transferor 41A. Consequently, it suffices that only one common control program used for the plurality of definition files in common is prepared for each revised version. This facilitates input and output management with respect to the memory 12.

### 2. When the Control Elements are Connected to a Control Unit Through Network

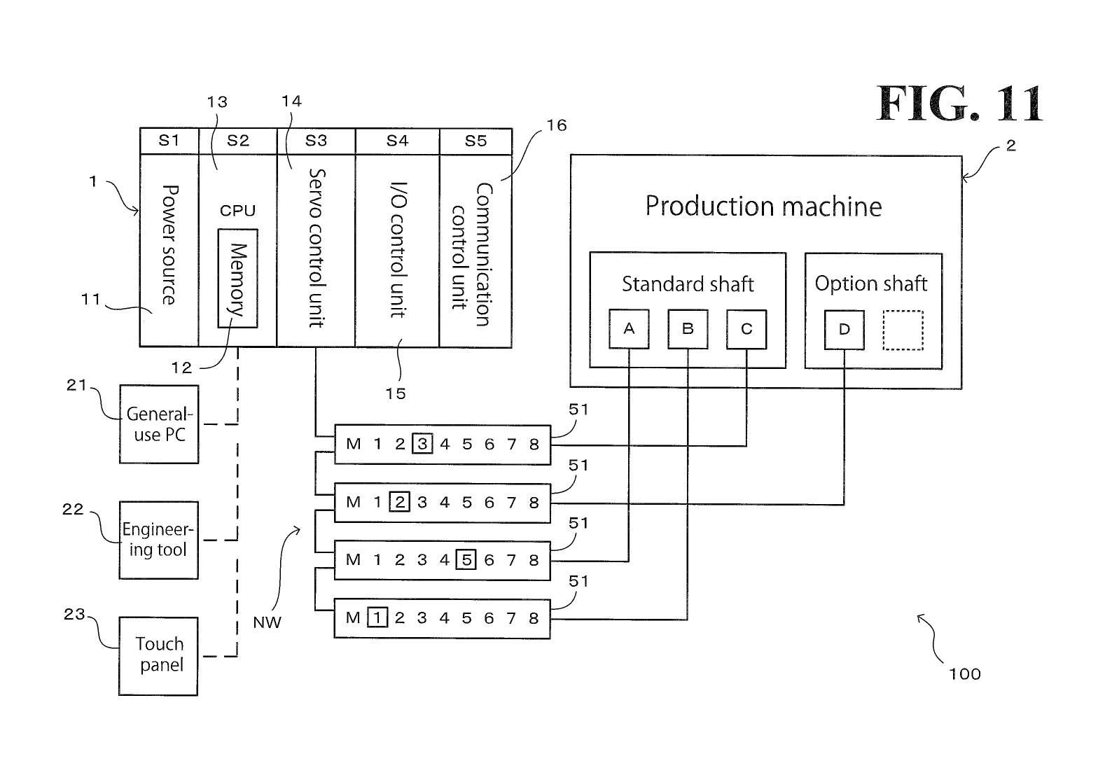

In the embodiment and the first modification, each control unit includes the plurality of ports P1 to P5 that can be individually specified, and the control unit is connected to the control elements of the production machine 2 through the ports P1 to P5. This, however, should not be construed in a limiting sense. For example, as illustrated in FIG. 11, each control unit may be connected to a plurality of node terminals 51 through network NW, and the node terminals 51 may be connected to the respective control elements of the production machine 2.

In the example illustrated in FIG. 11, MECHATROLINK (registered trademark) is supposed as the network NW. The servo control unit 14 and the node terminals 51 are connected in series in what is called cascade connection. Although the node terminals 51 made up of ASIC, for example, are compatible with each other as hardware, an optional and unique (not overlapping) node address as identification information is set for each node terminal 51 by predetermined software operation or hardware operation. In the example illustrated in FIG. 11, node address M3 is set for the node terminal 51 that is most closely connected to the servo control unit 14. Node address M2 is set for the second closest node terminal 51. Node address M5 is set for the third closest node terminal 51. Node address M1 is set for the fourth closest node terminal 51. The drive shaft A is connected to the node terminal 51 at node address M5. The drive shaft B is connected to the node terminal 51 at node address M1. The drive shaft C is connected to the node terminal 51 at node address M3. The drive shaft D is connected to the node terminal 51 at node address M2. It is noted that the node addresses M1 to M5 correspond to the specification information disclosed in the claims.

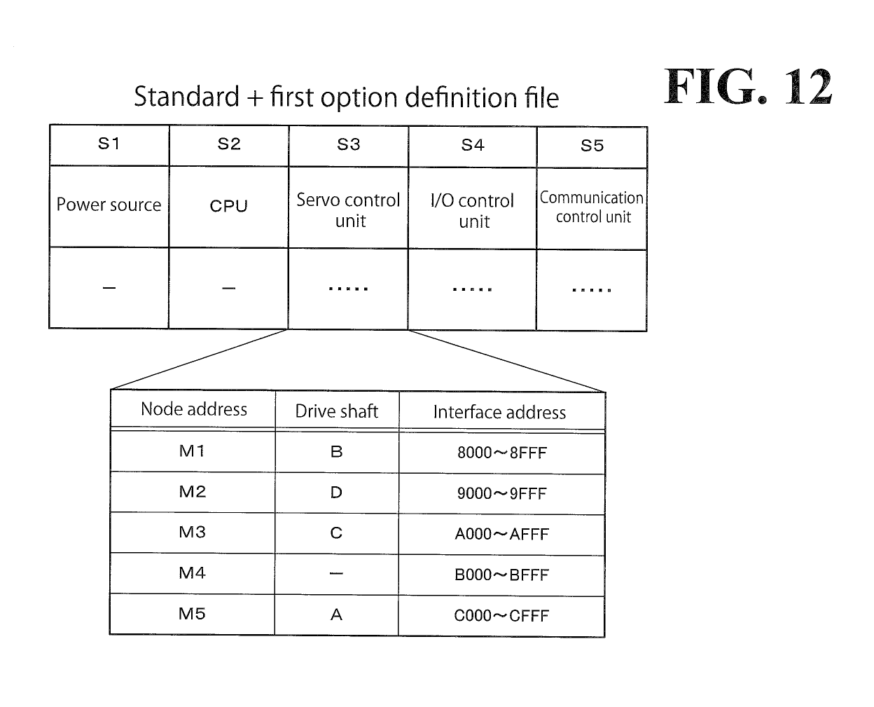

For the network connection having such a high freedom degree, it suffices that a definition file corresponding to the connection configuration is prepared, as illustrated in FIG. 12. The contents of the definition file in the example of FIG. 12 are described in a table indicating a combination, corresponding to each node address, of identification information of the drive shaft and an interface address where commands and information are actually input and output. In the control program, it suffices that when each drive shaft is controlled, the input and output of commands and information are performed with respect to the node terminal 51 at the corresponding node address based on the definition file (not illustrated).

As described above, the programmable controller 1 of this modification is connected through the network NW to the plurality of node terminals 51, which are respectively connected to the plurality of control elements. With the node addresses randomly and uniquely set respectively for the plurality of node terminals 51, it is specified the input-output ends of commands and/or information. Thus, the node addresses set with a high degree of freedom and randomly are used to specify the input-output ends of commands and/or information.

Otherwise, the above-described embodiments and modification may be combined in any manner deemed suitable.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A programmable controller to control a control machine, the programmable controller comprising:
an arithmetic processor;
a non-volatile storage storing a plurality of control projects executable by the arithmetic processor to perform control processing of the control machine;
a volatile storage configured to store at least one control project among the plurality of control projects; and
a selection transferor configured to select the at least one control project from among the plurality of control projects stored in the non-volatile storage and transfer the selected one control project to the volatile storage so that the arithmetic processor executes the at least one control project stored in the volatile storage.

2. The programmable controller according to claim 1, further comprising an area designation transferor configured to transfer the at least one control project stored in the volatile storage to a random storage area in the non-volatile storage.

3. The programmable controller according to claim 1, wherein the selection transferor is configured to select and transfer the at least one control project at start time of the programmable controller.

4. The programmable controller according to claim 1,
wherein the control project comprises
a plurality of definition files each defining a corresponding relationship between specification information and a plurality of control elements of the control machine, the specification information specifying an input-output end from and to which the programmable controller receives and outputs at least
one of a command and information, and
a control program executable by the arithmetic processor to input and output at least one of the command and the information from and to the plurality of control elements based on at least one definition file among the plurality of definition files, and
wherein the selected one control project comprises the plurality of definition files, and the selection transferor is configured to select at least one definition file from among the plurality of definition files of the selected one control project and configured to transfer the selected one definition file and the control program of the control project to the volatile storage.

5. The programmable controller according to claim 4, further comprising a plurality of connectors that are respectively connected to the plurality of control elements, wherein the specification information comprises information for individually specifying the connectors.

6. The programmable controller according to claim 4, wherein the programmable controller is connected through a network to a plurality of node terminals respectively connected to the plurality of control elements, wherein the specification information comprises pieces of unique and random identification information respectively for the plurality of node terminals.

7. The programmable controller according to claim 2, wherein the selection transferor is configured to select and transfer the at least one control project at start time of the programmable controller.

8. The programmable controller according to claim 2,
wherein the control project comprises
a plurality of definition files each defining a corresponding relationship between specification information and a plurality of control elements of the control machine, the specification information specifying an input-output end from and to which the programmable controller receives and outputs at least one of a command and information, and
a control program executable by the arithmetic processor to input and output at least one of the command and the information from and to the plurality of control elements based on at least one definition file among the plurality of definition files, and
wherein the selected one control project comprises the plurality of definition files, and the selection transferor is configured to select at least one definition file from among the plurality of definition files of the selected one control project and configured to transfer the selected one definition file and the control program of the control project to the volatile storage.

9. The programmable controller according to claim 3,
wherein the control project comprises
a plurality of definition files each defining a corresponding relationship between specification information and a plurality of control elements of the control machine, the specification information specifying an input-output end from and to which the programmable controller receives and outputs at least one of a command and information, and
a control program executable by the arithmetic processor to input and output at least one of the command and the information from and to the plurality of control elements based on at least one definition file among the plurality of definition files, and
wherein the selected one control project comprises the plurality of definition files, and the selection transferor is configured to select at least one definition file from among the plurality of definition files of the selected one control project and configured to transfer the selected one definition file and the control program of the control project to the volatile storage.

10. The programmable controller according to claim 7,
wherein the control project comprises
a plurality of definition files each defining a corresponding relationship between specification information and a plurality of control elements of the control machine, the specification information specifying an input-output end from and to which the programmable controller receives and outputs at least one of a command and information, and
a control program executable by the arithmetic processor to input and output at least one of the command and the information from and to the plurality of control elements based on at least one definition file among the plurality of definition files, and
wherein the selected one control project comprises the plurality of definition files, and the selection transferor is configured to select at least one definition file from among the plurality of definition files of the selected one control project and configured to transfer the selected one definition file and the control program of the control project to the volatile storage.

11. The programmable controller according to claim 8, further comprising a plurality of connectors that are respectively connected to the plurality of control elements, wherein the specification information comprises information for individually specifying the connectors.

12. The programmable controller according to claim 9, further comprising a plurality of connectors that are respectively connected to the plurality of control elements, wherein the specification information comprises information for individually specifying the connectors.

13. The programmable controller according to claim 10, further comprising a plurality of connectors that are respectively connected to the plurality of control elements, wherein the specification information comprises information for individually specifying the connectors.

14. The programmable controller according to claim 8, wherein the programmable controller is connected through a network to a plurality of node terminals respectively connected to the plurality of control elements, wherein the specification information comprises pieces of unique and random identification information respectively for the plurality of node terminals.

15. The programmable controller according to claim 9, wherein the programmable controller is connected through a network to a plurality of node terminals respectively connected to the plurality of control elements, wherein the specification information comprises pieces of unique and random identification information respectively for the plurality of node terminals.

16. The programmable controller according to claim 10, wherein the programmable controller is connected through a network to a plurality of node terminals respectively connected to the plurality of control elements, wherein the specification information comprises pieces of unique and random identification information respectively for the plurality of node terminals.
